(19) United States
(12) Patent Application Publication
(10) Pub. No.: US 2015/0213782 A1
(43) Pub. Date: Jul. 30, 2015

(54) TOUCH ELECTRONIC DEVICE AND DATA TRANSMISSION METHOD

(71) Applicant: MediaTek Singapore Pte. Ltd., Singapore (SG)

(72) Inventors: Xiaomeng YAN, Tianjin (CN); Lin XU, Tianjin (CN); Shang-Lun TING, Taipei City (TW)

(21) Appl. No.: 14/606,213

(22) Filed: Jan. 27, 2015

(30) Foreign Application Priority Data
Jan. 29, 2014 (CN) 201410043750.7

(51) Int. Cl. G09G 5/12; G06F 3/14; G06F 3/041

(52) U.S. Cl. CPC G09G 5/12; G06F 3/0412; G06F 3/1423; G09G 2370/16; G09G 2370/22; G09G 2354/00

(57) ABSTRACT

The present invention provides a touch electronic device and a data transmission method including a touch panel, a touch link module, a wireless transmission module and a control module. The touch link module is utilized to establish a first communication channel with at least one first touch electronic device through the touch panel, and receive at least one information from the at least one first touch electronic device through the first communication channel. The wireless transmission module is utilized to establish a second communication channel. The control module is utilized to receive the at least one information from the touch link module, divide an initial data into a plurality of sub-data according to the at least one information, and determine to transmit which sub-data of the plurality of sub-data to the at least one first touch electronic device through the first communication channel or the second communication channel.

### CROSS REFERENCE TO RELATED APPLICATIONS

This application claims priority of China Patent Application No. 201410043750.7, filed on Jan. 29, 2014, the entirety of which is incorporated by reference herein.

### BACKGROUND OF THE INVENTION

1. Field of the Invention

The present invention relates to an electronic device, and especially to a touch electronic device and a data transmission method using the same.

2. Description of the Related Art

Near Field Communication (NFC) is a contactless technology for identification and interconnection. Near Field Communication allows users to exchange information, access contacts and services by using the near field magnetic communication (such as the near field magnetic communication of 13.56 MHz) between mobile devices, consumer electronics, PCs or smart electronic devices.

Due to the maturity of the market, the mobile phone with NFC can either support the function of the mobile payment or serve as a point of sale (POS) apparatus. However, a proximity card reader or like elements must be added to the handheld device because NFC sends and receives signals through magnetic communication, and that will make the size of the handheld device larger, and the layout and the elements of the handheld device might be limited.

A touch-link technology of a touch panel device which uses the existing panel and driver IC for communication has been established recently, and has been described in US 2011/0304583, US 2013/0147760, CN 102916729A. The touch panel device includes a touch sensor. At least a part of the touch sensor includes at least a part of the touch panel of the touch panel device. The touch panel can be the touch panel without a display function, such as the touch pad, or with the display function, such as the touch screen. The touch sensor includes the driving electrodes and the sensing electrodes set on the board of the touch panel for forming the capacitance structure. At least one of the driving electrodes and the sensing electrodes is used as the sending electrode, and at least one is used as the receiving electrode. Thus, the signal can be sent and received by the existing electrodes and driver IC of the touch panel device for achieving the touch link based on the electric field without an additional proximity card reader or like element, reducing the size and the cost of the touch panel device.

FIG. 1 is a schematic diagram of the touch link between a first touch panel device and a second touch panel device in accordance with the prior art. As shown in FIG. 1, there are near fields 103a and 103b between the first touch panel device 101 and the second touch panel device 102. It should be noted that the first touch panel device 101 and the second touch panel device 102 are enabled to send and receive the signal. The first touch panel device 101 sends the signal to the second touch panel device 102 through a communication media which has an electric field pointed to the second touch panel device 102 (the near field 103a as shown in FIG. 1). The second touch panel device 102 sends the signal to the first touch panel device 101 through a communication media which has an electric field pointed to the first touch panel device 101 (the near field 103b as shown in FIG. 1). The X channel and the Y channel shown in FIG. 1 represent the sending electrodes and the receiving electrodes set on the board for forming the capacitance structure.

FIG. 2 is a logic diagram for achieving the touch link system between the first touch panel device and the second touch panel device in accordance with the prior art. The first touch panel device 101 includes a signal sending system 201 shown in FIG. 2, and the second touch panel device 102 includes a signal receiving system 202 shown in FIG. 2. The signal sending system 201 includes a touch link request signal generation unit 211, a communication connection establishing unit 212 and a first communication unit 213. The touch link request signal generation unit 211 is used to generate a request signal for touch link, and be sent to the second touch panel 102 through the sending electrode. The communication connection establishing unit 212 establishes a communication connection with the second touch panel device 102 after the receiving electrodes receive a response signal responded from the second touch panel device 102. The first communication unit 213 sends the communication information or the data to the second touch panel device 102 through the sending electrodes of the touch panel (not shown) after the communication connection is established.

The signal receiving system 202 includes a touch link request response unit 221, a communication connection establishing unit 222 and a second communication unit 223. The touch link request response unit 221 responds an acknowledge signal to the first touch panel device 101 through the sending electrodes after the receiving electrodes receive a touch link request signal sent from the first touch panel device 101. The communication connection establishing unit 222 establishes the communication connection with the first touch panel device 101 after the touch link request response unit 221 responses the acknowledge signal to the first touch panel device 101. The second communication unit 223 receives the communication information or the data sent from the first touch panel device 101 through the receiving electrodes after the communication connection is established.

FIG. 3 is a schematic illustrating the transmission and receiving of the signal by the electrodes of the touch panel with the prior art. As shown in FIG. 3, the touch sensor (not shown) includes the sending electrodes 311, 321 and the receiving electrodes 312, 322 disposed on the board for forming the capacitance structure. The sending electrodes 311, 321 are used to send the signal, and the receiving electrodes 312, 322 are used to receive the signal.

FIG. 4 is a flow chart of the touch link method in accordance with the prior art. First, in step S401, the touch link request signal generation unit 211 generates a touch link request signal, and sends it to the second touch panel device 102 through the sending electrodes. Then the receiving electrodes receive the acknowledge signal responded from the second touch panel device 102 (step S402). After that, the communication connection establishing unit 212 establishes the communication connection with the second touch panel device 102 (step S403). Finally, the method goes to step S404, and the first communication unit 213 sends the communication information or the data to the second touch panel device 102 through the sending electrodes.

Compared to ordinary keyboards or mouse devices, the touch operation can provide a more convenient and user-friendly operation method to users. Accordingly, more and more electronic devices are equipped with the touch function. However, the touch operation is usually a one-to-one operation between the user and the electronic device, or the one-to-one operation between two electronic devices. In addition, when the user wants to transmit different files to at least two electronic devices or share the same data among different electronic devices, it is very inconvenient to set up the network and connection for each electronic device. Therefore, a touch electronic device and data transmission method for transmitting data among at least two electronic devices according to the characteristics of the electronic device are needed.

### BRIEF SUMMARY OF THE INVENTION

The present invention provides a touch electronic device and a data transmission method to solve the above problems.

The present invention provides a touch electronic device including a touch panel, a touch link module, a wireless transmission module and a control module. The touch link module is utilized to establish a first communication channel with at least one first touch electronic device through the touch panel, and receive at least one information from the at least one first touch electronic device through the first communication channel. The wireless transmission module is utilized to establish a second communication channel. The control module is utilized to receive the at least one information from the touch link module, divide an initial data into a plurality of sub-data according to the at least one information, and determine which sub-data of the plurality of sub-data to transmit to the at least one first touch electronic device through the first communication channel or the second communication channel.

The present invention provides a data transmission method utilized for a touch electronic device. The data transmission method includes establishing a first communication channel with at least one first touch electronic device through a touch panel of the touch electronic device; receiving at least one information from the at least one first touch electronic device through the first communication channel; establishing a second communication channel; dividing an initial data into a plurality of sub-data according to the at least one information; and determining to transmit which sub-data of the plurality of sub-data to the at least one first touch electronic device through the first communication channel or the second communication channel.

The present invention provides a touch electronic device including a touch panel, a touch link module and a wireless transmission module. The touch link module is utilized to establish a first communication channel with a first touch electronic device through the touch panel, and transmit information to the first touch electronic device through the first communication channel. The wireless transmission module is utilized to establish a second communication channel. A data corresponding to the information is received from the first touch electronic device through the touch link module or the wireless transmission module.

The present invention provides a data transmission method utilized for a touch electronic device. The data transmission method includes establishing a first communication channel with a first touch electronic device through the touch panel; transmitting information to the first touch electronic device through the first communication channel; establishing a second communication channel; and receiving a sub-data corresponding to the information from the first touch electronic device through the first communication channel or the second communication channel.

By utilizing the touch electronic device and the data transmission method provided by the present invention, the sub-data corresponding to the characteristic or feature of the first touch electronic device could be transmitted to the first touch electronic device according to its characteristics or features.

### BRIEF DESCRIPTION OF THE DRAWINGS

The present invention can be more fully understood by reading the subsequent detailed description and examples with references made to the accompanying drawings, wherein:

FIG. 1 is a schematic diagram of the touch link between a first touch panel device and a second touch panel device in accordance with the prior art;

FIG. 2 is a logic chart for achieving the touch link system between the first touch panel device and the second touch panel device in accordance with the prior art;

FIG. 3 is a schematic diagram illustrating the transmission and reception of the signal by the electrodes of the touch panel with the prior art;

FIG. 4 is a flow chart of the touch link method in accordance with the prior art;

FIG. 5 is a schematic diagram illustrating a touch electronic device in accordance with one embodiment of the present invention;

FIG. 6A is a schematic diagram illustrating the touch link among a plurality of touch electronic devices in accordance with one embodiment of the present invention;

FIG. 6B is another schematic diagram illustrating the touch link among a plurality of touch electronic devices in accordance with another embodiment of the present invention;

FIG. 6C is another schematic diagram illustrating the touch link among a plurality of touch electronic devices in accordance with another embodiment of the present invention;

FIG. 7A is a schematic diagram illustrating the data transmission among a plurality of touch electronic devices in accordance with one embodiment of the present invention;

FIG. 7B is another schematic diagram illustrating the data transmission among a plurality of touch electronic devices in accordance with another embodiment of the present invention;

FIG. 8A is a schematic diagram illustrating the data transmission among a plurality of touch electronic devices with their characteristics in accordance with one embodiment of the present invention;

FIG. 8B is another schematic diagram illustrating the data transmission among a plurality of touch electronic devices with their characteristics in accordance with another embodiment of the present invention;

FIG. 9 is a schematic diagram illustrating the data transmission method in accordance with one embodiment of the present invention.

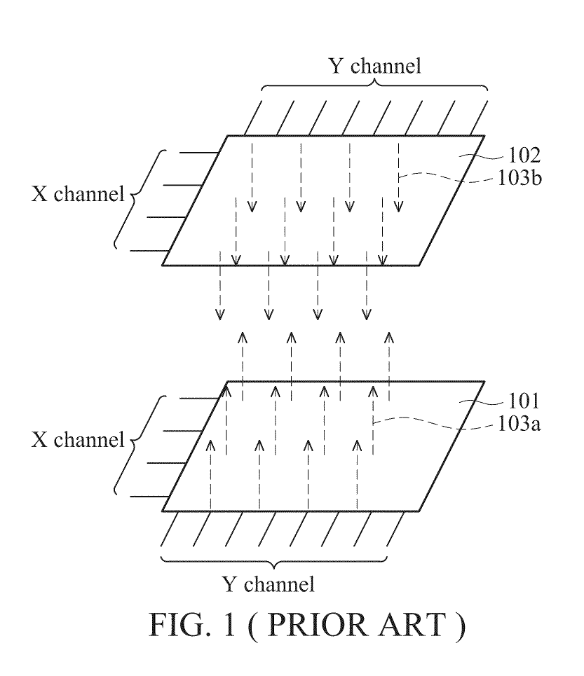

### DETAILED DESCRIPTION OF THE INVENTION

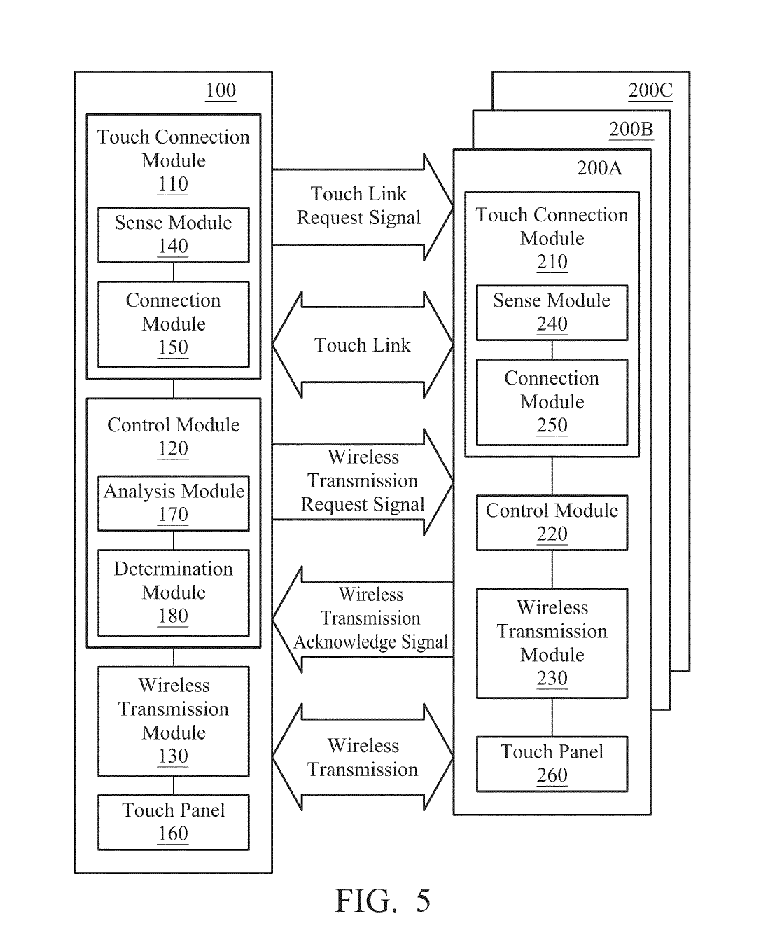

Certain terms and figures are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, the present invention is illustrated by the following embodiments and the FIG. 5 to FIG. 9. However, the devices, components, methods and steps in the following descriptions are used to explain the present invention, and are not used to limit it.

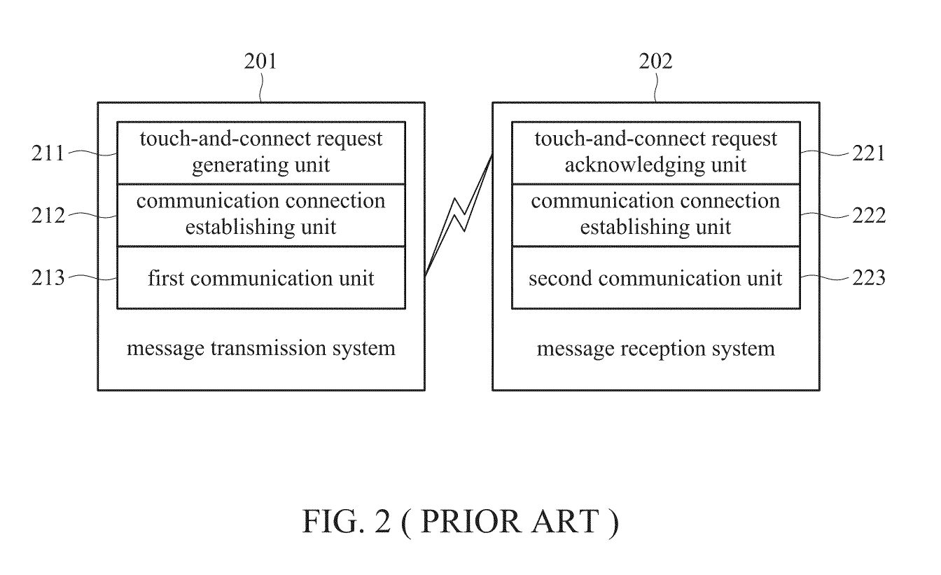

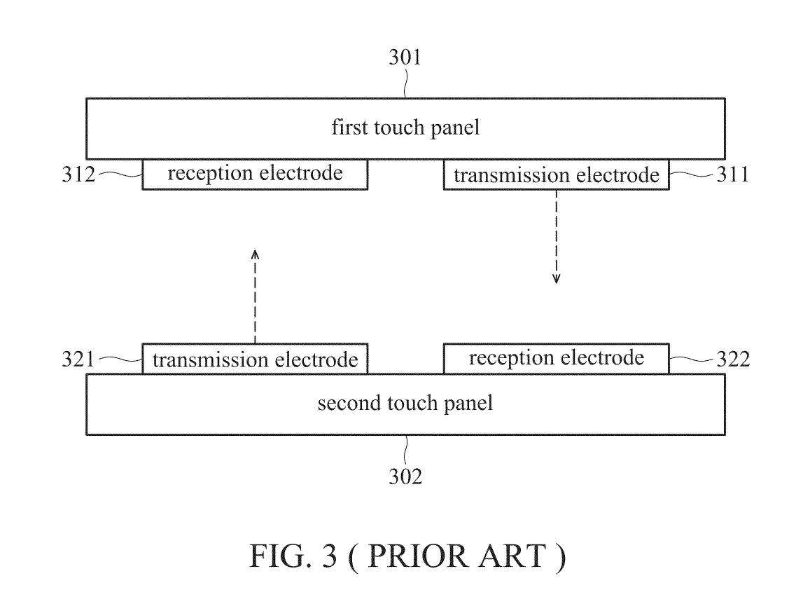

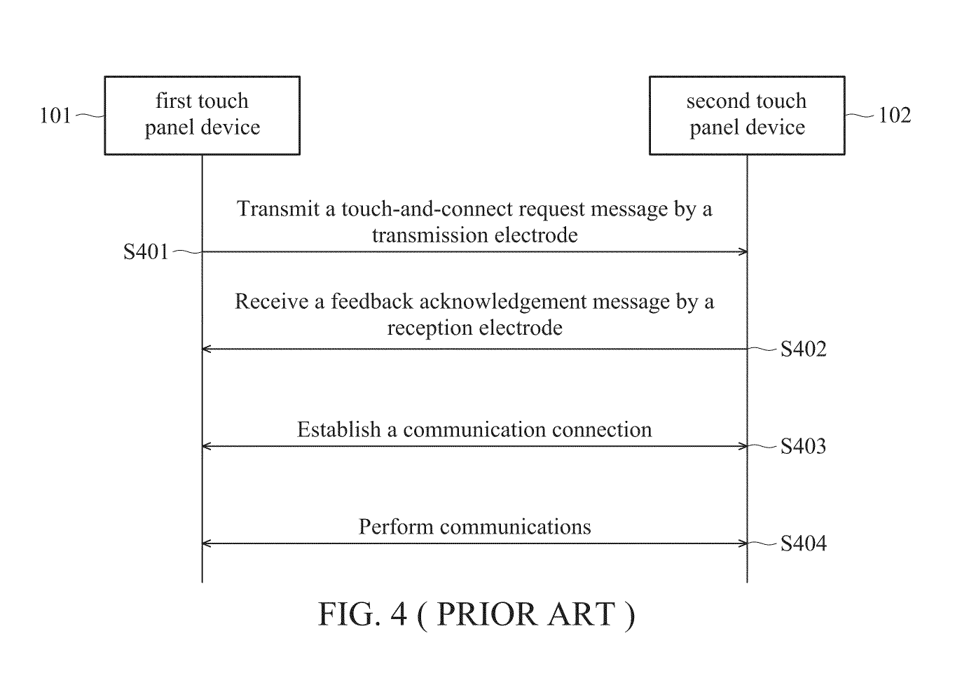

FIG. 5 is a schematic diagram illustrating a touch electronic device in accordance with one embodiment of the present invention. As shown in FIG. 5, the touch electronic device 100 includes a touch link module 110, a control module 120, a wireless transmission module 130 and a touch panel 160. The touch electronic devices 200A, 200B and 200C include touch link modules 210, control modules 220, wireless transmission modules 230 and touch panels 260. For example, the touch electronic devices 100, 200A, 200B and 200C could be mobile electronic devices such as cell phones, tablet computers, laptop computers or PDAs, or could be electronic devices such as desktop computers or servers, or could be any electronic devices equipped with touch link modules (such as touch IC). The control modules 120 and 220 could be digital signal processors (DSP), microcontrollers (MCU), central-processing units (CPU) or a plurality of parallel processors relating the parallel processing environment to implement the operating system (OS), firmware, driver and/or other applications of the electronic devices. In one embodiment, the touch link module 110 includes a sensing module 140 and a connection module 150. Similarly, the touch link module 210 includes a sensing module 240 and a connection module 250. The sensing module 140 and the sensing module 240 have the same or similar structures and functions. The connection module 150 and the connection module 250 have the same or similar structures and functions. Each touch electronic device 100, 200A, 200B and/or 200C detects the physical adjacency (such as being close or touching) with the devices by the sensing module 140 and/or 240. For example, the sensing module 140 detects whether the touch electronic device 100 is physically adjacent to the device. Once the physical adjacency is detected, the first communication channel is established through the connection module 150. For example, the sensing module 140 senses the interacting electromagnetic field (such as the method illustrated in FIG. 3, the interacting electromagnetic field is determined by the emitting electrode and the receiving electrode of the touch panel) between the touch electronic device 100 and the touch electronic device 200A. Whether the touch electronic device 200A is physically adjacent to the touch electronic device 100 or not is determined by changes in the electromagnetic field. When the physical adjacency is detected, the connection module 150 establishes the first communication channel with the connection module 250. In one embodiment, the connection module 150 could be the message transmission system as shown in FIG. 2, the connection module 250 could be the message reception system as shown in FIG. 2. the first communication unit 213 as shown in FIG. 2 establishes the first communication channel with the second communication unit 223 through the touch panel 160 of the touch electronic device 100 and the touch panel 260 of the touch electronic device 200A.

In an embodiment of the present invention, when the touch electronic device 100 detects the physical adjacency with the touch electronic device 200A, the connection module 150 of the touch link module 110 establishes the first communication channel with the connection module 250 of the touch electronic device 200A. The touch electronic device 200A transmits information to the touch link module 110 through the first communication channel. In one embodiment, the information indicates the characteristic information of the touch electronic device 200A. More specifically, the above characteristics include the panel size, the touch resolution, the proceeding speed, the panel resolution, the panel characteristics (such as multi-color or mono-color), the touch type (such as resistance touch or capacitive touch), the audio capability, the video capability, the sequence of the touch link or wireless communication with other touch electronic devices by the touch electronic device 200A. When the touch link module 110 receives the information, the control module 120 analyzes the characteristics of the touch electronic device 200A according to the above characteristics and divides the initial data which is to be transmitted by the touch electronic device 100 (e.g., the initial data will be transmitted by the touch electronic device 100 in a few minutes or seconds) into several sub-data according to the characteristics. In one embodiment, the initial data and the plurality of divided sub-data could include pictures in the format of JPEG, GIF, BMP, PNG or WBMP, or text in the format of SMS, MMA or HTML, or word files in the format of DOC, TXT, PPT, XLS, or the audio files in the format of mp3, WAV, OGG or AAC, or the video files in the format of AVI, MPEG4, mov, Xvid, 3GP or 3G2.

It should be noted that the control module 120 could adjust the weighting of the above characteristics to analysis the performance or characteristic of the touch electronic device 200A according to the data to be transmitted, received or processed. In one embodiment, when the initial data to be transmitted by the touch electronic device 100 is an audio file, the control module 120 increases the weighting about the audio capability to analyze the characteristics of the touch electronic device 200A. In another embodiment, when the initial data to be transmitted by the touch electronic device 100 is a picture file, the control module 120 increases the weighting about the panel size and the panel resolution to analysis the performance of the touch electronic device 200A. In another embodiment, when the initial data to be transmitted by the touch electronic device 100 is a video file, the control module 120 increases the weighting about the video capability to analysis the performance of the touch electronic device 200A.

In another embodiment, when the touch electronic device 100 detects its physical adjacency with the touch electronic device 200A, the connection module 150 of the touch link module 110 establishes the first communication channel with the connection module 250 of the touch electronic device 200A. The touch link module 110 transmits the first information to the touch electronic device 200A through the first communication channel. The first information relates to the initial data to be transmitted. For example, the first information indicates the type, the data size, the expected transmission period of the initial data and so on. After the touch electronic device 200A receives the first information, it analysis the first information and transmits the indication information to the touch link module 110 through the first communication channel. The indication information is used to indicate the touch electronic device 100 about which portions of the initial data are going to be received after the touch electronic device 200A analyze its own characteristics.

It should be noted that the format of the information transmitted by the touch electronic device 200A could be set according to the needs of the designer. Therefore, in one embodiment, the control module 120 could further include an analysis module 170. The analysis module 170 is used to analyze the information transmitted by the touch electronic device 200A (for example, the format of the information is converted to a readable format for the touch electronic device 100). Accordingly, the control module 120 could divide the initial data according the analyzed information.

As shown in FIG. 5, in the touch electronic device 100, the wireless transmission module 130 is also coupled to the control module 120. The wireless transmission module 130 establishes the second communication channel with the touch electronic device 200A. The second communication channel executes wireless communication on the basis of a wireless communication protocol. The protocol of wireless communication could comprise GSM, GPRS, EDGE, UMTS, W-CDMA, CDMA2000, TD-CDMA, Bluetooth, NFC, WiFi, WiMAX, LTE, LTE-A or TD-LTE etc. In one embodiment, the control module 120 further includes a determination module 180. After the control module 120 divides the initial data into a plurality of sub-data, the determination module 180 determines the data size corresponding to the respective plurality of sub-data. When the data size is larger than or equal to the predetermined value, the wireless transmission module 130 is utilized to transmit the sub-data corresponding to the data size through the second communication channel. When the data size is smaller than the predetermined value, the connection module 150 is utilized to transmit the sub-data corresponding to the data size through the first communication channel. In another embodiment, the determination module 180 can also determine the choice made by the user to use the first communication channel or the second communication channel for transmitting sub-data according to the choice of the user. For example, when the user chooses the first communication channel to transmit sub-data, the first communication channel will be utilized regardless of the data size of the corresponding sub-data.

The wireless transmission module 130 can transmit sub-data at a level speed of thousands of symbols per second. Each symbol could correspond to any suitable amounts of data bit (for example, 0.5 bit/symbol, 1 bit/symbol and so on). The wireless transmission module 130 can implement many other data speeds which could be greater than or less than thousands of symbols per second in various kinds of embodiments. It should be noted that the implementations of the sense module 240, the connection module 250, the control module 220 and the wireless transmission module 230 of the touch electronic device 200A are similar to the implementations of the sense module 140, the connection module 150, the control module 120 and the wireless transmission module 130 of the touch electronic device 100, and it would not be repeated. The above embodiment describes the data transmission between the touch electronic device 100 and another touch electronic device 200A. However, the present invention is not limited thereto. Based on the same principle and steps, the touch electronic device 100 can establish communication and transmit data with several touch electronic devices (such as touch electronic devices 200A, 200B and 200C), and it would not be repeated.

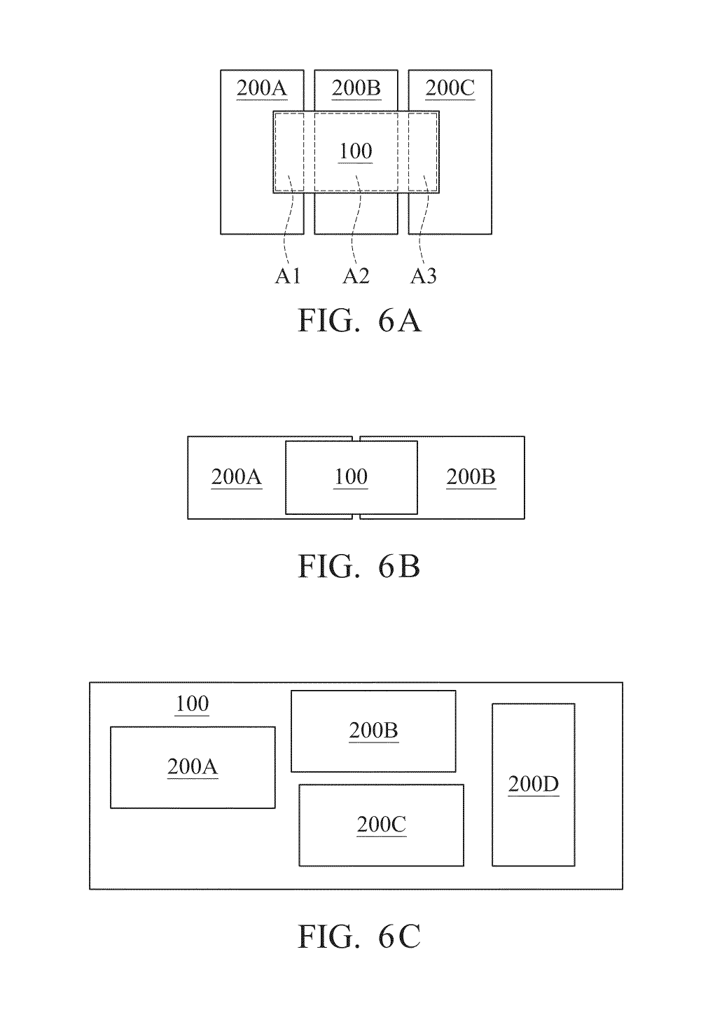

FIG. 6A is a schematic diagram illustrating the touch link among a plurality of touch electronic devices in accordance with one embodiment of the present invention. As shown in FIG. 6A, the touch electronic device 100 is physically adjacent to the touch electronic devices 200A, 200B and 200C. The adjacent areas of the touch electronic device 100 with the touch electronic devices 200A, 200B and 200C are A1, A2 and A3 respectively. When the touch electronic device 100 and the touch electronic device 200A are close to each other for establishing communications, the electromagnetic field which is originally related to the touch electronic device 100 could affect the sense module 240 of the touch electronic device 200A. Similarly, another electromagnetic field which is originally related to the touch electronic device 200A could affect the sense module 140 of the touch electronic device 100. When the distance of the touch electronic device 100 and the touch electronic device 200A is in the scale of millimeters (mm), for example, 5 mm, they can be considered to be adjacent. The distance is determined by the features of the related touch electronic device and its sense module. For example, the distance of 3 mm to 8 mm could be considered physically adjacent. In other words, when the distance of the touch electronic device 100 and the touch electronic device 200A is smaller than or equal to a predetermined maximum distance (such as 5 mm), the touch electronic device 100 determines that it is physical adjacent to the touch electronic device 200A.

In one embodiment, the contact area A1 of the touch electronic devices 100 and 200A is larger than the predetermined area value, and the touch electronic device 100 determines that it is adjacent to or in contact with the touch electronic device 200A. In one embodiment, the predetermined area value is one-fourth to one-third of the touch screen of the touch electronic device 100. In another embodiment, the predetermined area value is about 20% to 40% of the touch screen of the touch electronic device 100. For example, the predetermined area value is 35% of the touch screen of the touch electronic device 100. Since the contact area A2 is larger than the predetermined area value, the touch electronic device 100 determines it is adjacent to or in contact with the touch electronic device 200B. Since the contact area A1 or A3 is not larger than the predetermined area value, the touch electronic device 100 determines that it is not adjacent to or contacts the touch electronic device 200A or 200C.

FIG. 6B is another schematic diagram illustrating the touch link among a plurality of touch electronic devices in accordance with another embodiment of the present invention. The touch electronic device 100 covers the touch screens of the touch electronic devices 200A and 200B. FIG. 6C is another schematic diagram illustrating the touch link among a plurality of touch electronic devices in accordance with another embodiment of the present invention. As shown in FIG. 6C, the touch screen of the touch electronic device 100 is covered by the touch electronic devices 200A, 200B, 200C and 200D. Accordingly, the adjacency, contact or covering among several touch electronic devices could be considered as a manner of touch link. Whether the touch link is effective or not and whether the touch link is completed or not could be determined by the distance and/or the contact area between the touch electronic devices.

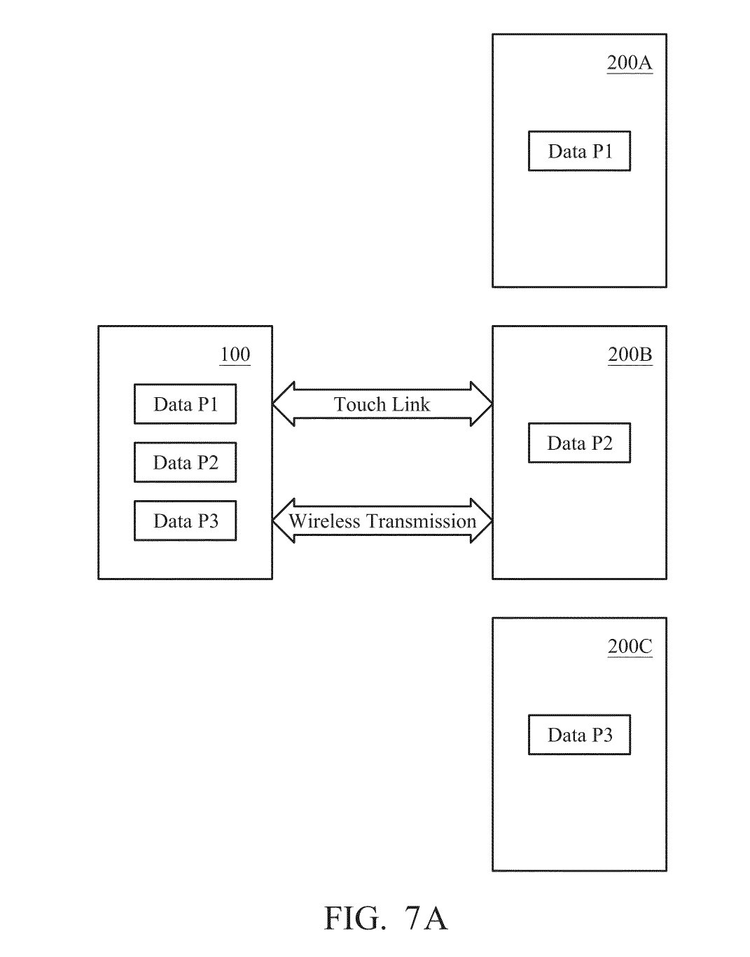

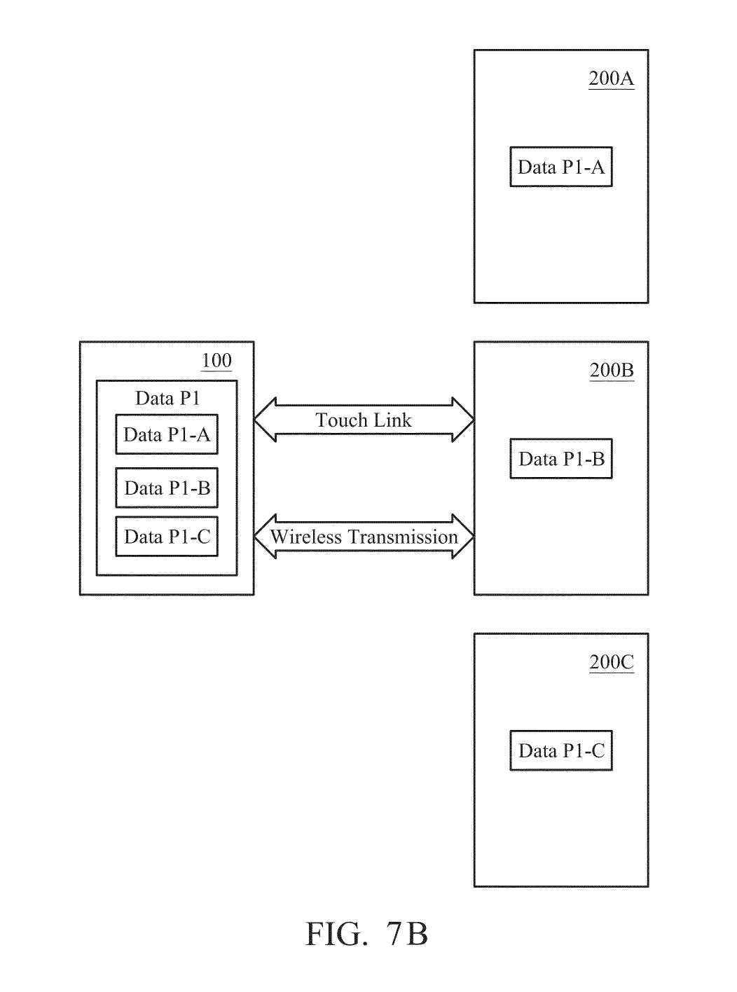

FIG. 7A is a schematic diagram illustrating the data transmission among a plurality of touch electronic devices in accordance with one embodiment of the present invention. In this embodiment, the touch electronic device 100 transmits the corresponding data P1, P2 and P3 to the touch electronic devices 200A, 200B and 200C according to the indication information of the touch electronic devices 200A, 200B and 200C. FIG. 7B is another schematic diagram illustrating the data transmission among a plurality of touch electronic devices in accordance with another embodiment of the present invention. In this embodiment, the touch electronic device 100 divides the data P1 into sub-data P1-A, P1-B and P1-C according to the characteristic information of the touch electronic device 200A, 200B and 200C, and transmits the corresponding sub-data P1-A, P1-B and P1-C to the touch electronic device 200A, 200B and 200C respectively. In other words, the touch electronic device 200A, 200B and 200C respectively obtain a portion of the data P1 according to their own performances or characteristics.

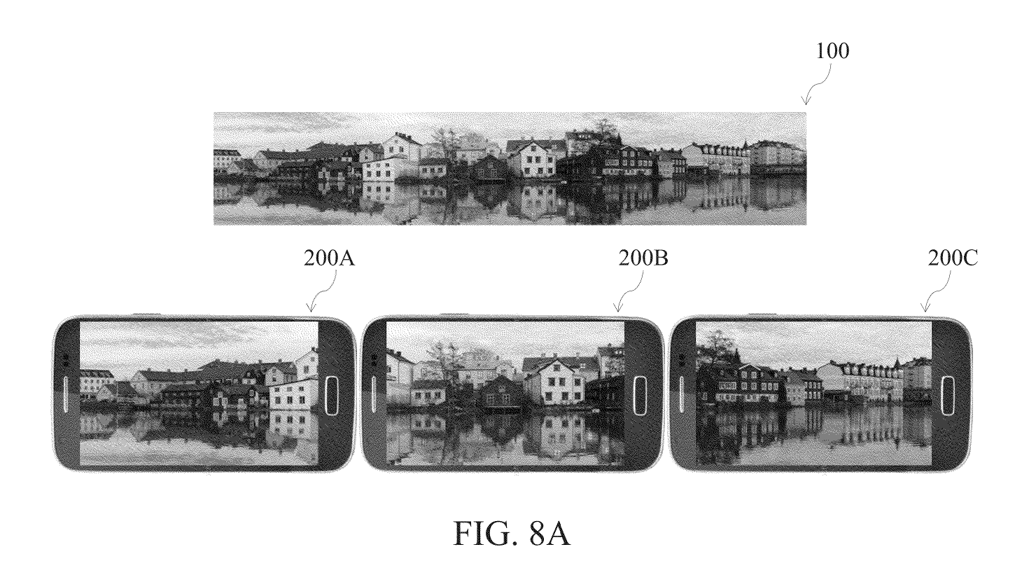

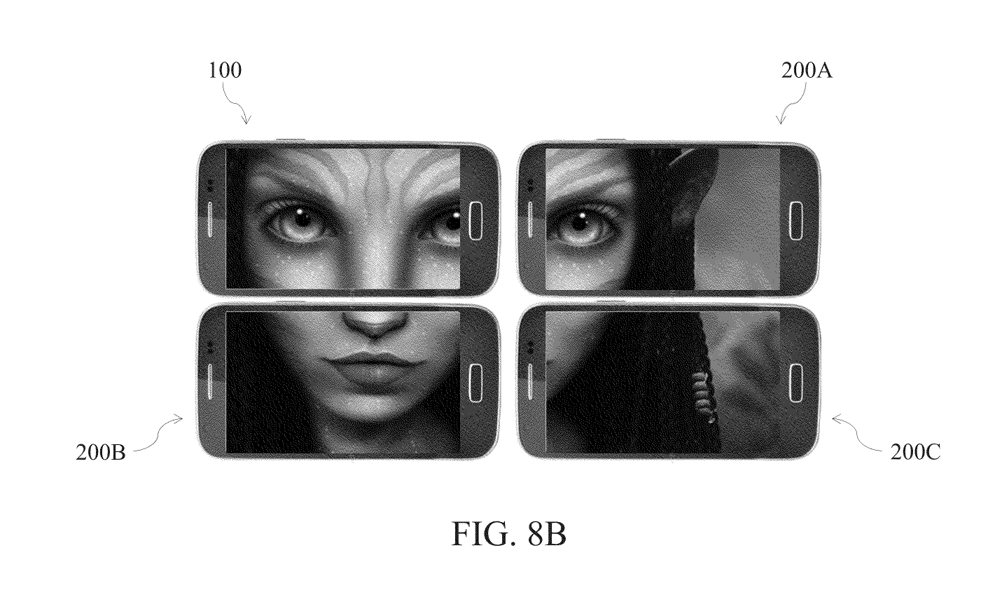

FIG. 8A is a schematic diagram illustrating the data transmission among a plurality of touch electronic devices with their characteristics in accordance with one embodiment of the present invention. In this embodiment, the touch electronic device 100 displays the original picture (the initial data), divides the original picture into three sub-pictures (i.e., several sub-data) according to the information (such as the characteristic information or the indication information) transmitted by each touch electronic device 200A, 200B and 200C, and transmits the three sub-pictures to the touch electronic devices 200A, 200B and 200C respectively. Finally, the touch electronic devices 200A, 200B and 200C individually display a portion of the original picture. Therefore, the original picture could be completely displayed by combining the touch electronic devices 200A, 200B and 200C.

FIG. 8B is another schematic diagram illustrating the data transmission among a plurality of touch electronic devices with their characteristics in accordance with another embodiment of the present invention. Each touch electronic device 200A, 200B, 200C and 200D receives a portion of images respectively according to its own characteristics. Finally, the touch electronic device 200A, 200B, 200C and 200D plays the received portion of images respectively. Therefore, the images can be completely played by combining the touch electronic devices 200A, 200B, 200C and 200D.

In another embodiment, the touch electronic device 100 divides an original music data into three sub-music data according to the information (such as the characteristic information or the indication information) transmitted by each touch electronic device 200A, 200B and 200C, and transmits the three sub-music data to the touch electronic devices 200A, 200B and 200C respectively. Finally, the touch electronic devices 200A, 200B and 200C play a portion of the original music data respectively. Therefore, the original music data could be completely played by combining the touch electronic devices 200A, 200B and 200C. For example, the touch electronic device 100 divides the original music data into three sub-music data of the high frequency, the middle frequency and the low frequency. Because the touch electronic device 200A has a better capability of playing audios of low frequencies, the touch electronic device 200A plays the sub-music data of low frequency, and the touch electronic devices 200B and 200C play the sub-music data of middle frequency and high frequency.

In another embodiment, the touch electronic device 100 could be the chief service apparatus of a shopping center. The touch electronic devices 200A, 200B and 200C could be the portable devices used by the customers. The chief service apparatus divides the shopping center information (the initial data) into three sub-data (such as the sub-data for the membership of different levels) according to the characteristic information (such as the membership of different levels) transmitted by the mobile devices. Afterwards, the chief service apparatus transmits the three sub-data to the touch electronic devices 200A, 200B and 200C respectively. Finally, the touch electronic devices 200A, 200B and 200C respectively receive the shopping center information corresponding to their memberships of different levels.

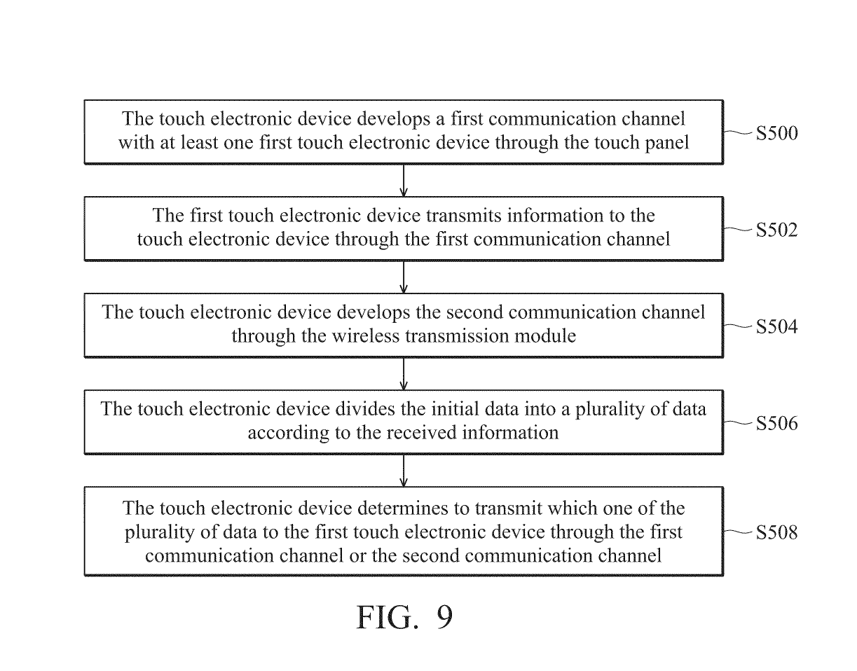

FIG. 9 is a schematic diagram illustrating the data transmission method in accordance with one embodiment of the present invention. In step S500, the touch electronic device 100 establishes a first communication channel with at least one first touch electronic device through the touch panel 160. Specifically, when the touch electronic device 100 detects that it is physically adjacent (for example, the distance between the touch electronic device 100 and the first touch electronic device is less than or equal to the predetermined maximum distance, such as 5 mm) to at least one first touch electronic device (such as the touch electronic devices 200A, 200B and/or 200C), the connection module 150 of the touch electronic device 100 establishes the first communication channel through the touch panel 160. In step S502, the first touch electronic device transmits information to the touch electronic device 100 through the first communication channel. The form of the information has been described in the above paragraphs, and would not be repeated. In step S504, the touch electronic device 100 establishes the second communication channel through the wireless transmission module 130. In step S506, the touch electronic device 100 divides the initial data into a plurality of sub-data according to the received information. The details have been described in the above paragraphs, and would not be repeated. In step S508, the touch electronic device 100 determines to transmit which one of the plurality of sub-data to the first touch electronic device through the first communication channel or the second communication channel. Specifically, in one embodiment, the touch electronic device 100 transmits the data of the plurality of sub-data which is corresponding to the information to the first touch electronic device. The touch electronic device 100 further determines the data size of the sub-data. When the data size is smaller than or equal to the predetermined value, the sub-data is transmitted through the first communication channel. When the data size is larger than the predetermined value, the sub-data is transmitted through the second communication channel. In another embodiment, the touch electronic device 100 determines the choice of the user, and utilizes the first communication channel or the second communication channel to transmit one of the plurality sub-data to the first touch electronic device according to the choice of the user. It should be noted that the number of the steps above does not represent their execution sequence. The execution sequence could be modified by the persons skilled in the art with their own designs and needs. For example, step S504 could be executed before step S502 or after step S506. It should be illustrated that, in one embodiment, the touch electronic device 100 could establish the first communication channel with the at least one first touch electronic device (such as the touch electronic devices 200A, 200B and/or 200C) and transmit the corresponding sub-data in different period of time. For example, the touch electronic device 100 establishes the first communication channel with the touch electronic device 200A at first, receives the information from the touch electronic device 200A through the first communication channel, divides the initial data into several sub-data by utilizing the information, and transmits the data of the several sub-data corresponding to the touch electronic device 200A. Afterwards, the touch electronic device 100 establishes the first communication channel with the touch electronic device 200B, receives the information from the touch electronic device 200B through the first communication channel, divides the initial data into several sub-data by utilizing the information, and transmits the data of the several sub-data corresponding to the touch electronic device 200B, and the like.

In another embodiment, the touch electronic device 100 could establish the first communication channel with the at least one first touch electronic device (such as the touch electronic devices 200A, 200B and/or 200C) and transmit the corresponding sub-data at the same time. For example, the touch electronic device 100 establishes the first communication channel with the touch electronic devices 200A, 200B and 200C at the same time, receives the information from the touch electronic devices 200A, 200B and 200C through the first communication channel, divides the initial data into several sub-data by utilizing the information, and transmits the data of the several sub-data corresponding to the touch electronic devices 200A, 200B and 200C respectively.

Accordingly, the present invention provides a touch electronic device and data transmission method for transmitting data among at least two electronic devices according to the characteristics or performances of the electronic devices. By utilizing the touch electronic device and data transmission method of the present invention, the users do not need to set up the network and connection for each electronic device. The files could easily be shared between different electronic devices or be transmitted to at least two electronic devices according to the characteristic or performances of the electronic devices, wherein, the files are corresponding to each characteristic of the electronic device respectively.

While the invention has been described by way of example and in terms of the preferred embodiments, it is to be understood that the invention is not limited to the disclosed embodiments. On the contrary, it is intended to cover various modifications and similar arrangements as would be apparent to those skilled in the art. In addition, those skilled in the art should appreciate that they can readily use the disclosed conception and specific embodiments as a basis for designing or modifying other structures for carrying out the same purposes of the present invention without departing from the scope of the invention as defined by the appended claims.

What is claimed is:

1. A touch electronic device, comprising:
a touch panel;
a touch link module, utilized to establish a first communication channel with at least one first touch electronic device through the touch panel, and receive at least one information from the at least one first touch electronic device through the first communication channel;
a wireless transmission module, utilized to establish a second communication channel; and
a control module, utilized to receive the at least one information from the touch link module, divide an initial data into a plurality of sub-data according to the at least one information, and determine to transmit which sub-data of the plurality of sub-data to the at least one first touch electronic device through the first communication channel or the second communication channel.

2. The touch electronic device as claimed in claim 1, wherein the touch link module comprises:
a sense module, utilized to detect a physical adjacency between the touch electronic device and the at least one first touch electronic device; and
a connection module, utilized to establish the first communication channel through the touch panel when the sense module detects the physical adjacency.

3. The touch electronic device as claimed in claim 2, wherein when the distance between the touch electronic device and the at least one first touch electronic device is smaller than or equal to 5 mm, the sense module determines that the touch electronic device is physically adjacent to the at least one first touch electronic device.

4. The touch electronic device as claimed in claim 1, wherein the information is a characteristic information of the at least one first touch electronic device.

5. The touch electronic device as claimed in claim 4, wherein the control module divides the initial data into the plurality of sub-data according to the characteristic information.

6. The touch electronic device as claimed in claim 1, wherein the information is an indication information of the at least one first touch electronic device, and the indication information indicates a portion of the initial data to be received by the at least one first touch electronic device.

7. The touch electronic device as claimed in claim 6, wherein the control module divides the initial data into the plurality of sub-data according to the indication information.

8. The touch electronic device as claimed in claim 2, wherein the control module further comprises:
an analysis module, utilized to analyze the at least one information transmitted by the at least one first touch electronic device, and the control module divides the initial data according to the analyzed information.

9. The touch electronic device as claimed in claim 1, wherein the sub-data corresponding to the information of the plurality of sub-data is transmitted to the first touch electronic device which transmits the information.

10. The touch electronic device as claimed in claim 1, wherein the control module further comprises:
a determination module, utilized to determine the data size which corresponds to the plurality of sub-data respectively, and the sub-data corresponding to the data size is transmitted through the first communication channel when the data size is smaller than or equal to a predetermined value, and the sub-data corresponding to the data size is transmitted through the second communication channel when the data size is larger than the predetermined value.

11. The touch electronic device as claimed in claim 1, wherein the control module further comprises:
a determination module, utilized to determine a choice made by a user, and the plurality of sub-data are transmitted to the at least one first touch electronic device through the first communication channel or the second communication channel according to the choice.

12. A data transmission method, utilized for a touch electronic device, comprising:
establishing a first communication channel with at least one first touch electronic device through a touch panel of the touch electronic device;
receiving at least one information from the at least one first touch electronic device through the first communication channel;
establishing a second communication channel;
dividing an initial data into a plurality of sub-data according to the at least one information; and
determining to transmit which sub-data of the plurality of sub-data to the at least one first touch electronic device through the first communication channel or the second communication channel.

13. The data transmission method as claimed in claim 12, wherein the data transmission method further comprises, when detecting that a distance between the touch electronic device and the at least one first touch electronic device is smaller than or equal to 5 mm, establishing the first communication channel.

14. The data transmission method as claimed in claim 12, wherein the information is a characteristic information of the at least one first touch electronic device.

15. The data transmission method as claimed in claim 14, further comprising dividing the initial data into the plurality of sub-data according to the characteristic information.

16. The data transmission method as claimed in claim 12, wherein the information is an indication information of the at least one first touch electronic device, and the indication information indicates a portion of the initial data to be received by the at least one first touch electronic device.

17. The data transmission method as claimed in claim 16, further comprising dividing the initial data into the plurality of sub-data according to the indication information.

18. The data transmission method as claimed in claim 12, wherein the step of dividing the initial data into the plurality of data according to the at least one information further comprises:
receiving and analyzing the at least one information transmitted by the at least one first touch electronic device, and dividing the initial data according to the analyzed information.

19. The data transmission method as claimed in claim 12, wherein the step of transmitting the plurality of sub-data to the at least one first touch electronic device further comprises transmitting the plurality of sub-data to the at least one first touch electronic device at the same time or in different periods of time.

20. The data transmission method as claimed in claim 12, wherein the step of transmitting which sub-data of the plurality of sub-data to the at least one first touch electronic device through the first communication channel or the second communication channel further comprises:
transmitting the data corresponding to the information of the plurality of sub-data to the first touch electronic device which transmits the information.

21. The data transmission method as claimed in claim 12, wherein the step of transmitting which sub-data of the plurality of sub-data to the at least one first touch electronic device through the first communication channel or the second communication channel further comprises:
determining a data size which corresponds to the respective plurality of sub-data, wherein the sub-data corresponding to the data size is transmitted through the first communication channel when the data size is smaller than or equal to a predetermined value, and the sub-data corresponding to the data size is transmitted through the second communication channel when the data size is larger than the predetermined value.

22. The data transmission method as claimed in claim 12, wherein the step of transmitting which sub-data of the plurality of sub-data to the at least one first touch electronic device through the first communication channel or the second communication channel further comprises:
determining a choice made by a user, wherein the plurality of sub-data are transmitted to the at least one first touch electronic device through the first communication channel or the second communication channel according to the choice.

23. A touch electronic device, comprising:
a touch panel;
a touch link module, utilized to establish a first communication channel with a first touch electronic device through the touch panel, and transmit information to the first touch electronic device through the first communication channel; and
a wireless transmission module, utilized to establish a second communication channel, wherein a data corresponding to the information is received from the first touch electronic device through the touch link module or the wireless transmission module.

24. The touch electronic device as claimed in claim 23, wherein the touch link module comprises:
a sense module, utilized to detect a physical adjacency between the touch electronic device and the first touch electronic device; and
a connection module, utilized to establish the first communication channel through the touch panel when the sense module detects the physical adjacency.

25. The touch electronic device as claimed in claim 24, wherein when the distance between the touch electronic device and the first touch electronic device which is smaller than or equal to 5 mm is detected by the sense module, the sense module determines that the touch electronic device is physically adjacent to the first touch electronic device.

26. The touch electronic device as claimed in claim 23, wherein the information is characteristic information of the touch electronic device.

27. The touch electronic device as claimed in claim 26, wherein the touch link module or the wireless transmission module receives a data corresponding to the characteristic information from the first touch electronic device.

28. The touch electronic device as claimed in claim 23, wherein the information is an indication information of the touch electronic device, and the indication information indicates the kind of the data of the first touch electronic device to be received by the touch electronic device.

29. The touch electronic device as claimed in claim 28, wherein the touch link module or the wireless transmission module receives a data corresponding to the indication information from the first touch electronic device.

30. The touch electronic device as claimed in claim 23, wherein the data is received by the touch link module through the first communication channel when the data size of the data is smaller than or equal to a predetermined value, and the data is received by the touch link module through the second communication channel when the data size of the data is larger than the predetermined value.

31. The touch electronic device as claimed in claim 23, wherein the data is received by the touch link module through the first communication channel or the second communication channel according to a choice made by a user.

32. A data transmission method, utilized for a touch electronic device, comprising:
establishing a first communication channel with a first touch electronic device through the touch panel of the touch electronic device;
transmitting information to the first touch electronic device through the first communication channel;
establishing a second communication channel; and
receiving a data corresponding to the information from the first touch electronic device through the first communication channel or the second communication channel.

33. The data transmission method as claimed in claim 32, wherein the data transmission method further comprises establishing the first communication channel when the distance between the touch electronic device and the first touch electronic device which is smaller than or equal to 5 mm is detected.

34. The data transmission method as claimed in claim 32, wherein the information is characteristic information of the touch electronic device.

35. The data transmission method as claimed in claim 34, further comprising receiving a data corresponding to the characteristic information from the first touch electronic device through the touch link module or the wireless transmission module.

36. The data transmission method as claimed in claim 32, wherein the information is an indication information of the touch electronic device, and the indication information indicates the kind of the data to be received from the first touch electronic device.

37. The data transmission method as claimed in claim 36, further comprising receiving a data corresponding to the indication information from the first touch electronic device by the touch link module or the wireless transmission module.

38. The data transmission method as claimed in claim 32, wherein the step of receiving a data corresponding to the information from the first touch electronic device through the first communication channel or the second communication channel further comprises:
receiving the data through the first communication channel when the data size of the data is smaller than or equal to a predetermined value, and receiving the data through the second communication channel when the data size of the data is larger than the predetermined value.

39. The data transmission method as claimed in claim 32, wherein the step of receiving a data corresponding to the information from the first touch electronic device through the first communication channel or the second communication channel further comprises:
receiving the data corresponding to the information through the first communication channel or the second communication channel according to a choice of a user.
